(19) United States
(12) Patent Application Publication
(10) Pub. No.: US 2026/0010189 A1
(43) Pub. Date: Jan. 8, 2026

(54) COMPARATOR-BASED VOLTAGE REGULATION SYSTEM

(71) Applicant: Robert Bosch GmbH, Stuttgart (DE)

(72) Inventor: Vadim Pozhidaev, Reutlingen (DE)

(21) Appl. No.: 19/246,830

(22) Filed: Jun. 24, 2025

(30) Foreign Application Priority Data
Jul. 4, 2024 (DE) 10 2024 206 329.0

(51) Int. Cl. G05F 1/575

(52) U.S. Cl. CPC G05F 1/575

(57) ABSTRACT

A voltage regulation system. The voltage regulation system includes: a semiconductor switch for setting an output voltage on the basis of a gate voltage, a first switch and a second switch which are configured to increase or decrease the gate voltage when in the closed state, a clocked comparator configured to compare the output voltage and a reference voltage, an actuation logic configured to operate the first switch and the second switch according to a comparison of the outputs of the comparator of two successive clock cycles, and a polarity switch configured to swap the inputs of the comparator for the output voltage and the reference voltage for each clock cycle of the comparator.

### CROSS REFERENCE

The present application claims the benefit under 35 U.S.C. § 119 of German Patent Application No. DE 10 2024 206 329.0 filed on Jul. 4, 2024, which is expressly incorporated herein by reference in its entirety.

### FIELD

The present invention relates to a comparator-based voltage regulation system which operates with a comparator and a reference voltage.

### BACKGROUND INFORMATION

Various voltage regulation systems are described in the related art. The low-dropout (LDO) regulator is a popular solution for many power management units (PMUs) because it is efficient and operates without switching noise. However, traditional LDOs based on an analog error amplifier are not very scalable. In addition, supply voltages are being designed lower and lower, which makes the design of an analog error amplifier significantly more difficult. Therefore, digital LDOs have been developed, which use comparators instead of amplifiers. The digital LDOs utilize output-side transistors which operate in a switching mode and not in the saturation range. However, the output signal becomes highly rippled due to these transistors. Thus, usually large capacitive or inductive loads are needed to smooth the signal.

China Patent Application No. CN 112 947 662 A describes a voltage regulation system that counteracts the ripple of the output signal by means of two comparators. The voltage regulation system therefore operates with two reference voltages.

U.S. Patent Application No. US 2020/0127569 A1 describes a voltage regulation system in which a low-pass filter for filtering the high-frequency components of a PWM signal is arranged on the output side.

### SUMMARY

A voltage regulation system according to certain features of the present invention makes it possible to regulate a voltage with only one comparator and a reference voltage. In addition, no large load is required on the output side to smooth the output signal.

According to an example embodiment of the present invention, the voltage regulation system comprises a semiconductor switch for setting an output voltage Vₒᵤₜ on the basis of a gate voltage V_{G}, a first switch and a second switch which are configured to increase or decrease the gate voltage V_{G} when in the closed state, a clocked comparator for comparing the output voltage Vₒᵤₜ and a reference voltage V_{Ref}, an actuation logic for operating the first switch and the second switch according to a comparison of the outputs of the comparator of two successive clock cycles, and a polarity switch configured to swap the inputs of the comparator for the output voltage Vₒᵤₜ and the reference voltage V_{Ref} for each clock cycle of the comparator. By means of this design, a hysteresis can be caused in a comparator-based LDO by using the offset voltage of the comparator. The voltage regulator can thus be operated with low supply voltage and, at the same time, with low output ripple. In addition, no large capacitive or inductive output load is necessary to reduce the output ripple. Moreover, low-frequency noise in the voltage regulator according to the present invention is not transferred to the output; it affects only the voltage limits of the hysteresis.

Preferred developments of the present invention are disclosed herein.

According to an example embodiment of the present invention, preferably, the actuation logic comprises a 2-bit shift register which is formed in particular by two D flip-flops. Due to the bistability of the D flip-flop, a state of the D flip-flop can be stored for an unlimited time. Thus, past states can be taken into account in the present consideration.

In one example embodiment of the present invention, the 2-bit shift register is connected on the input side to an XOR gate configured to invert the output of the comparator. Thus, a signal is output only if a signal is present at one of the inputs. If a signal is present at both inputs, no signal is output at the output of the XOR gate.

The inverting outputs of the D flip-flops are preferably connected to a NAND gate and a NOR gate. The NAND gate causes a signal output when only one of the inputs of the NAND gate receives a signal. The NOR gate causes a signal output only when no signal is present at both inputs of the NOR gate.

The first switch is actuatable by the NAND gate, and the second switch is actuatable by the NOR gate. Thus, the switches can be actuated differently by means of the same input signals.

The comparator is in particular in the form of a dynamic feedback latch. Comparators of this type are highly scalable, as well as energy-efficient and space-efficient.

In a further example embodiment of the present invention, the actuation logic comprises a mode switching logic, the mode switching logic being configured to choose between two operating modes and preferably comprising more than three flip-flops. By means of the mode switching logic, the circuit can be switched from a normal mode to an accuracy mode and to a speed mode. The circuit can thus be adapted to various operating requirements.

In the accuracy mode, a first supply current of the first switch and a second supply current of the second switch are reduced to a minimum value to ensure stability. In the speed mode, the first supply current of the first switch and the second supply current of the second switch are raised to a maximum value to reach the desired output voltage faster. The supply currents are, in particular, at least twice as large in the speed mode as in the normal operating mode of the circuit. The supply currents can be set either via a defined specification or by means of voltage-controlled current sources as a function of the voltage difference between the reference voltage and the output voltage. Depending on the desired mode of functioning of the circuit, it is also possible to select the value of the supply currents of the two switches from the value range between the minimum value and the maximum value. Voltage-controlled current sources as supply currents allow for faster transient times when glitches occur or during startup of the circuit.

According to an example embodiment of the present invention, advantageously, the mode switching logic is configured to short-circuit the signal of the comparator to the first switch and the second switch, and to short-circuit the output voltage signal and the reference voltage signal to the input of the comparator. The short-circuiting of the signal of the comparator to the first switch and the second switch occurs via transmission gates or logic gates when all the bits of the shift register are equal. The short-circuiting processes reduce delays in signal transmission.

Preferably, according to an example embodiment of the present invention, a capacitance is arranged downstream of the first switch and the second switch, said capacitance maintaining the gate voltage V_{G} of the semiconductor switch. Voltage fluctuations at the semiconductor switch are thereby kept low. In addition, faster adjustment of the voltage is possible.

For the swapping of the inputs of the comparator, the clock signal of the polarity switch is preferably half as fast as the clock signal of the comparator. This prevents the polarity switch from swapping the inputs during an ongoing comparison. The probability of generating erroneous signals at the output of the comparator thus decreases sharply.

The present invention also relates to a method in which, for regulation of the gate voltage V_{G}, a first supply current of the first switch and a second supply current of the second switch are raised to a maximum value. The desired output voltage can thus be reached more quickly. The method can be carried out with the voltage regulation system described above.

According to an example embodiment of the present invention, in a further method step, for regulation of the gate voltage V_{G} the first supply current of the first switch and the second supply current of the second switch are reduced to a minimum value. This increases the stability of the circuit.

### BRIEF DESCRIPTION OF THE DRAWINGS

Embodiment examples of the present invention are described in detail below with reference to the figures.

FIG. 1 shows a block diagram of the voltage regulation system according to an example embodiment of the present invention.

FIG. 2 shows a block diagram of the voltage regulation system according to an example embodiment of the present invention with a logic circuit.

FIG. 3 shows a voltage diagram of the voltage regulation system according to an example embodiment of the present invention, plotted over time.

FIG. 4 shows a block diagram of the voltage regulation system according to an example embodiment of the present invention in a further operating mode.

### DETAILED DESCRIPTION OF EXAMPLE EMBODIMENTS

All same components, elements, and/or units are preferably provided with the same reference signs in all of the figures.

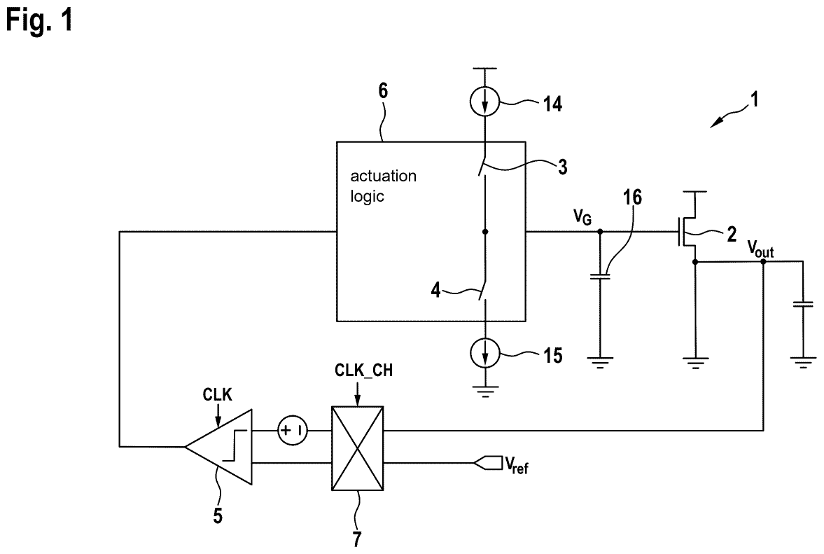

FIG. 1 shows a voltage regulation system 1 comprising a semiconductor switch 2 for setting an output voltage Vₒᵤₜ on the basis of a gate voltage V_{G}, as well as a first switch 3 and a second switch 4 which are configured to increase or decrease the gate voltage V_{G} when in the closed state. The voltage regulation system 1 of FIG. 1 further comprises a clocked comparator 5 configured to compare the output voltage Vₒᵤₜ and a reference voltage V_{Ref}, as well as an actuation logic 6 configured to operate the first switch 3 and the second switch 4 according to a comparison of the outputs of the comparator 5 of two successive clock cycles. In addition, the voltage regulation system comprises a polarity switch 7 configured to swap the inputs of the comparator 5 for the output voltage Vₒᵤₜ and the reference voltage V_{Ref} for each clock cycle of the comparator 5. If two successive clock cycles are not equal, either the first switch 3 or the second switch 4 is actuated. The output of the comparator 5 is compared with the inverted output of the comparator 5 in the next clock cycle. If the difference with Vₒᵤₜ as minuend and V_{ref} as subtrahend is greater than the inherent offset voltage of the comparator 5, the second switch is actuated to reduce the gate voltage V_{G} and thus Vₒᵤₜ by discharging a capacitance 16 by the amount of the second supply current 15. If the difference with V_{Ref} as minuend and Vₒᵤₜ as subtrahend is greater than the inherent offset voltage of the comparator 5, the first switch is actuated to increase the gate voltage V_{G} and thus Vₒᵤₜ by charging the capacitance 16 by the amount of the first supply current 15. If Vₒᵤₜ and V_{Ref} are equal or the difference between the two values is below the inherent offset voltage of the comparator 5, the gate voltage V_{G} is maintained at the same value via the capacitance 16. The capacitance 16 is preferably in the form of a capacitor. Energy is therefore used only in the exchanging of the inputs of the comparator 5 and in the case of voltage regulation. In some cases, voltage regulation may occur solely via the semiconductor switch 2, which in particular is in the form of a MOSFET. To this end, the MOSFET operates in the source follower mode. A capacitance 16 is disposed downstream of the first switch 3 and the second switch 4, said capacitance maintaining the gate voltage V_{G} of the semiconductor switch 2. For the swapping of the inputs of the comparator 5, the clock signal of the polarity switch 7 is half as fast as the clock signal of the comparator 5.

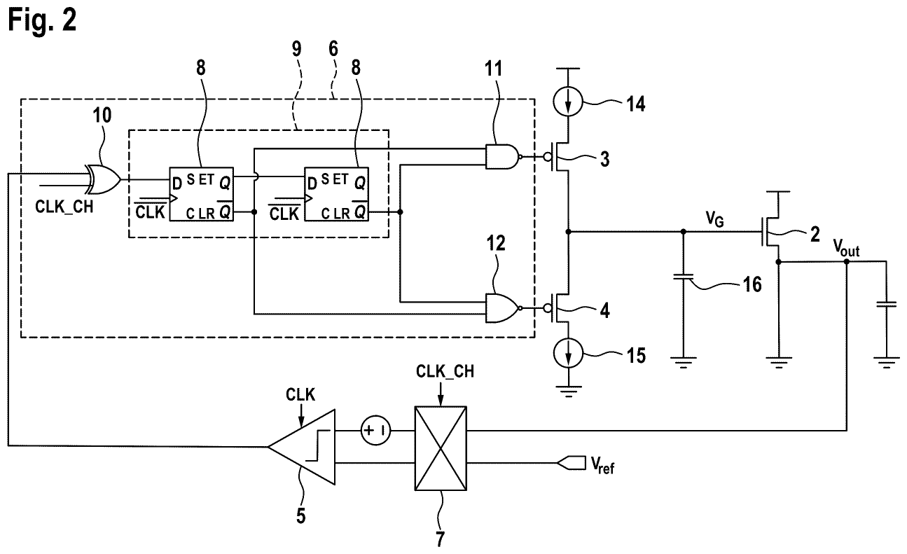

In FIG. 2, the interconnection of the logic gates of the actuation logic 6 is included in a circuit diagram. The actuation logic 6 comprises a 2-bit shift register 9 which, in the embodiment example shown, is formed by two D flip-flops 8. The 2-bit shift register 9 is connected on the input side to an XOR gate 10 configured to invert the output of the comparator 5. The inverting outputs of the D flip-flops 8 are each connected to a NAND gate 11 and a NOR gate 12. The first switch 3 is actuatable by the NAND gate 11, and the second switch 4 is actuatable by the NOR gate. The second switch 4 is actuated when both D flip-flops 8 are in state “1”, i.e. a logical one. The first switch 3 is actuated when both D flip-flops 8 are in state “0”, i.e. a logical zero. In all other cases, no current flows through the first switch 3 and the second switch 4.

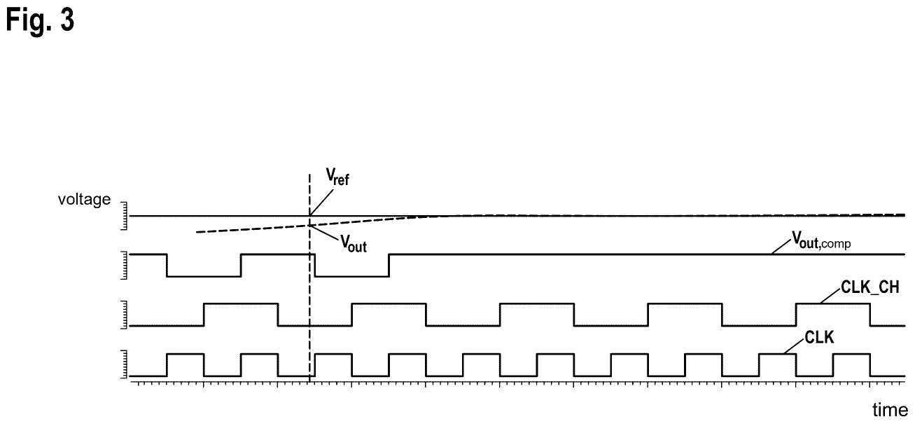

FIG. 3 shows that, for the swapping of the inputs of the comparator 5, the clock signal of the polarity switch 7 is half as fast as the clock signal of the comparator 5. The output voltage of the comparator 5 alternates until the time at which the difference between the output voltage Vₒᵤₜ and the reference voltage V_{Ref} falls below a specified threshold value. When the desired voltage level for Vₒᵤₜ is reached, the comparator signal remains constant.

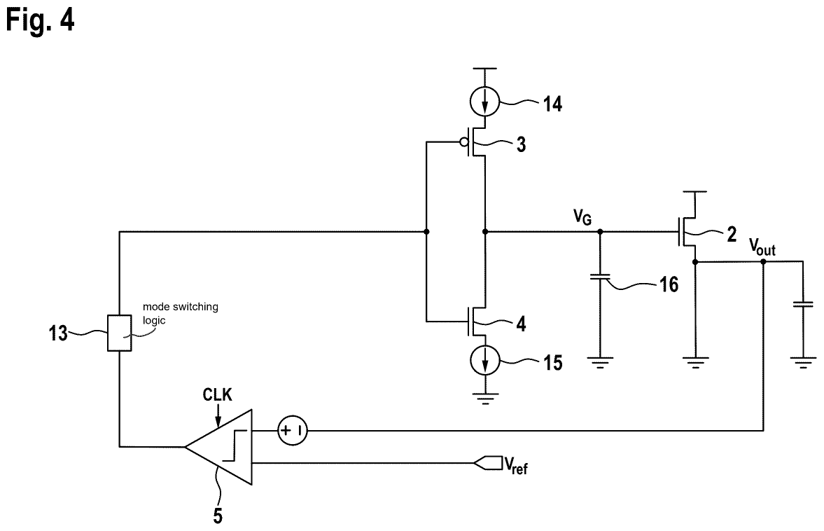

FIG. 4 illustrates how the speed mode of the mode switching logic 13 functions. The mode switching logic 13 is indicated as a separate block in FIG. 4, since it short-circuits the signal of the comparator 5 to the first switch 3 and the second switch 4 and thereby bypasses the rest of the actuation logic 6.

However, the mode switching logic is preferably configured as part of the actuation logic 6. The mode switching logic 13 also causes the short-circuiting of the output voltage signal and the reference voltage signal to the input of the comparator 5. For regulation of the gate voltage V_{G} in the speed mode, the first supply current 14 of the first switch 3 and the second supply current 15 of the second switch 4 are raised to a maximum value. In a preferred embodiment, the mode switching logic 13 is configured to choose between two operating modes and has more than three flip-flops. The operating modes include, in addition to the speed mode, a normal mode and an accuracy mode. In the accuracy mode, for regulation of the gate voltage V_{G} the first supply current 14 of the first switch 3 and the second supply current 15 of the second switch 4 are reduced to a minimum value. In the normal mode, the supply currents 14, 15 are at a base value. The base value is preferably between the minimum value and the maximum value of the supply currents 14, 15. Switching from the accuracy mode to the speed mode, and vice versa, thus occurs via the normal mode. In another embodiment, switching from the accuracy mode to the speed mode, and vice versa, also occurs directly. The desired voltage regulation can thus be set with less delay.

What is claimed is:

1. A voltage regulation system, comprising:
a semiconductor switch configured to set an output voltage based on a gate voltage;
a first switch and a second switch which are configured to increase or decrease the gate voltage when in a closed state;
a clocked comparator configured to compare the output voltage and a reference voltage;
an actuation logic configured to operate the first switch and the second switch according to a comparison of outputs of the comparator of two successive clock cycles; and
a polarity switch configured to swap inputs of the comparator for the output voltage and the reference voltage for each clock cycle of the comparator.

2. The voltage regulation system according to claim 1, wherein the actuation logic includes a 2-bit shift register which is formed by two D flip-flops.

3. The voltage regulation system according to claim 2, wherein the 2-bit shift register is connected on an input side to an XOR gate configured to invert the output of the comparator.

4. The voltage regulation system according to claim 2, wherein inverting outputs of the D flip-flops are connected to a NAND gate and a NOR gate.

5. The voltage regulation system according to claim 4, wherein the first switch is actuatable by the NAND gate and the second switch is actuatable by the NOR gate.

6. The voltage regulation system according to claim 1, wherein the comparator is a dynamic feedback latch.

7. The voltage regulation system according to claim 1, wherein the actuation logic includes a mode switching logic, the mode switching logic being configured to choose between two operating modes and includes more than three flip-flops.

8. The voltage regulation system according to claim 7, wherein the mode switching logic is configured to:
short-circuit a signal of the comparator to the first switch and the second switch; and
short-circuit an output voltage signal and a reference voltage signal to the input of the comparator.

9. The voltage regulation system according to claim 1, wherein a capacitance is arranged downstream of the first switch and the second switch, the capacitance maintaining the gate voltage of the semiconductor switch.

10. The voltage regulation system according to claim 1, wherein, for the swapping of the inputs of the comparator, a clock signal of the polarity switch is half as fast as a clock signal of the comparator.

11. A method for operating the voltage regulation system, the voltage regulation system including:
a semiconductor switch configured to set an output voltage based on a gate voltage,
a first switch and a second switch which are configured to increase or decrease the gate voltage when in a closed state,
a clocked comparator configured to compare the output voltage and a reference voltage,
an actuation logic configured to operate the first switch and the second switch according to a comparison of outputs of the comparator of two successive clock cycles; and
a polarity switch configured to swap inputs of the comparator for the output voltage and the reference voltage for each clock cycle of the comparator;
the method comprising the following steps:
regulating of the gate voltage by raising, to a maximum value, a first supply current of the first switch and a second supply current of the second switch.

12. The method according to claim 11, wherein, for the regulation of the gate voltage, the first supply current of the first switch and the second supply current of the second switch are reduced to a minimum value.
